(19) United States
(12) Patent Application Publication
(10) Pub. No.: US 2012/0095743 A1
(43) Pub. Date: Apr. 19, 2012

(54) MOLECULAR STRUCTURE ANALYSIS AND MODELING

(75) Inventor: Jacob Ary Flohil, CZ Delft (NL)

(73) Assignee: FOLDYNE TECHNOLOGY B. V., Eindhoven (NL)

(21) Appl. No.: 13/379,785

(22) PCT Filed: Jun. 24, 2009
(86) PCT No.: PCT/EP2009/057896

§ 371 Date: Dec. 21, 2011

(51) Int. Cl. G06G 7/48; G06F 19/12

(52) U.S. Cl. 703/11

(57) ABSTRACT

The invention generally relates to computational analysis and modeling of molecular structures and intermolecular interactions. More particularly, the invention concerns methods for determining the conformation of molecules including biomolecules, and methods for determining the molecular structure of complexes comprising such molecules. The invention may generally involve a reiterative communication between a docking and side-chain packing simulation on the one hand and a molecular dynamics (MD) simulation on the other hand. This allows to analyze backbone conformation changes that may arise due to intermolecular interactions upon the formation of a complex, yielding information more representative of the actual conformational events in and/or state of the complex. The invention may be used inter alia for analyzing and modeling the structure of proteins, protein-protein and protein-ligand interactions, and for protein and ligand design and engineering.

### FIELD OF THE INVENTION

The invention generally relates to computational analysis and modelling of molecular structures and intermolecular interactions. More particularly, the invention concerns methods for determining the conformation of molecules including biomolecules, and methods for determining the molecular structure of complexes comprising such molecules. The invention further relates to programs and program products for implementing the present methods, storage media storing the programs, and computing devices such as computers configured to execute the methods and programs. The invention may be used inter alia for analysing and modelling the structure of proteins, protein-protein and protein-ligand interactions, and for protein and ligand design and engineering.

### BACKGROUND OF THE INVENTION

Intermolecular interactions involving proteins play a central role in biological processes.

Commonly, a given protein may interact with one or more same or other proteins or non-protein ligands to form comparatively transient or permanent complexes. Some examples of biologically relevant protein interactions include the formation of oligomeric or multimeric protein complexes, antigen-antibody interactions, hormone-receptor interactions, protein-substrate or protein-inhibitor interactions, and protein interactions in signal transduction pathways.

Given the fundamental importance of protein-protein and protein-ligand interactions in biology, modulation of such interactions would allow to selectively impinge on desired biological processes and pathways, thus allowing for targeted therapeutic interventions and less unwanted side effects. Hence, there persists an intense need to unravel and more accurately simulate the molecular details of interactions involving proteins, inter alia to enable therapeutic modulation of these interactions. Also, therapeutic agents including antibodies and small molecules frequently act through binding to respective protein targets. Improved understanding of this binding may allow to engineer and optimise such therapeutic agents, for example to enhance their effectiveness and specificity.

Nowadays, numerous laboratory techniques allow to rapidly discover and verify large numbers of protein interactions, including for example yeast two-hybrid screening assays (Young 1998. Biol Reprod 58(2): 302-311) and high-throughput mass spectrometry assays. Moreover, the molecular structure of complexes comprising proteins may be studied by experimental methods such as X-ray crystallography. However, said experimental methods are hampered by technical constraints inter alia because of the weak and/or transient nature of interactions involved in many complexes, and failure to prepare adequate quantities of intact complexes for analysis. The molecular structure of countless biologically intriguing complexes therefore remains uncharacterised experimentally, as corroborated by the small number and slow addition of molecular structures of protein complexes in the Protein Data Bank database (Berman et al. 2000. Nucleic Acids Res 28(1): 235-242; Vajda and Camacho 2004. Trends Biotechnol 22(3): 110-116).

Computational methods for simulating molecular interactions and predicting the molecular structure of complexes have thus become a key tool in structural analysis. Generally, such computational methods depart from experimentally and/or computationally predetermined conformations of the unbound constituents of a complex and proceed to optimally dock said constituents. While early docking methods relied on rigid-body docking algorithms which searched for complementary surfaces in static structures of binding partners constituting a complex, more recent methods mainly employ semi-rigid-body docking algorithms which allow for re-packing of the side chains of protein binding partners to somewhat approximate conformational changes of the proteins that may facilitate interaction. An example of the latter docking methods is the “RosettaDock” method described by Gray et al. 2003 (J Mol Biol 331(1): 281-99).

However, it has become increasingly apparent that the formation of complexes especially involving proteins is frequently associated with conformational changes not only in the side chains but also in the backbones of such protein binding partners vis-à-vis their unbound conformations. This phenomenon is commonly denoted as induced fit binding. Because conventional docking methods maintain an unchanged conformation of the backbones of the protein binding partners, they are on the whole ill-suited for predicting the molecular structure of complexes in which the (protein) constituents undergo substantial conformational changes including changes to their backbones to achieve binding (e.g., induced fit situations).

Consequently, there continues a need for methods to analyse, predict and model the molecular structure of complexes, particularly complexes comprising protein constituents, which methods more accurately model conformational changes in the constituents upon forming the complex vis-à-vis their unbound conformations. Particularly, methods are required that allow for conformational changes in both backbones and side chains of protein constituents forming a complex.

### SUMMARY OF THE INVENTION

The present invention generally aims to advance computational methods for analysing and modelling intermolecular interactions and hence analysing and modelling the molecular structure of complexes comprised of interacting constituents (molecules). In particular, the invention aims to devise methods allowing to more realistically predict conformational alterations and adjustments which take place in constituents of a complex upon the interaction of said constituents leading to the formation of the complex. Also in particular, the invention aims to provide a closer approximation of induced fit interactions and complexes involving such interactions.

Hence, an object of the invention is to generate information about the molecular structure of a complex comprising interacting constituents and about the conformation of said constituents themselves.

The invention preferably concerns complexes which include one or more constituent molecules comprising a backbone and side-chains, such as for example one or more biomolecules, e.g., one or more proteins, polypeptides and/or peptides.

In contrast to previous docking simulations known to the Applicant, which generally do not make an allowance for changes in the backbone conformation of molecules constituting a complex, the invention does consider and model backbone conformation changes that may arise due to intermolecular interactions upon the formation of the complex. The approach adopted by the invention thus aims to produce information more representative of the actual conformational events in and/or state of the complex.

To address these aims, the invention provides aspects and embodiments as set out below and in the appended claims.

Hence, an aspect relates to a method for determining a molecular structure of a complex comprising two or more constituents, wherein one or more of said constituents is a molecule comprising backbone and side-chains, the method comprising:

(a) receiving a starting molecular structure of said complex including receiving:
(a1) starting conformations of said constituents; and
(a2) starting pose of said constituents;
   (b) receiving a target molecular structure of said complex including receiving:
(b1) target conformations of said constituents, wherein one or more side-chain dihedral angles differ between the starting and target conformations of at least one of the constituent molecule(s) comprising backbone and side-chains; and
(b2) target pose of said constituents;
   (c) perturbing the starting molecular structure of the complex by performing a molecular dynamics simulation thereon, thereby determining a first intermediate molecular structure of the complex, characterised in that the molecular dynamics simulation comprises exerting a supplemental force on one or more atoms or one or more groups of atoms of at least one of the constituent molecule(s) comprising backbone and side-chains such as to modify one or more side-chain dihedral angles of said molecule(s) to at least partly converge towards the corresponding side-chain dihedral angles of the target conformation of said molecule(s);
   (d) relaxing the first intermediate molecular structure of the complex by performing a molecular dynamics simulation thereon without exerting said supplemental forces, thereby determining a second intermediate molecular structure of the complex;
   (e) supplying the second intermediate molecular structure of the complex to a docking and side-chain packing simulation, thereby determining a third intermediate molecular structure of the complex;
   (f) reiterating steps (a) to (e), wherein at each reiteration the second intermediate molecular structure of the complex determined in step (d) is received in step (a) as the starting molecular structure of the complex, and the third intermediate molecular structure of the complex determined in step (e) is received in step (b) as the target molecular structure of the complex; and
   (g) optionally and preferably, outputting data comprising information on a molecular structure of the complex as determined in any of the preceding steps, to a data storage medium or to a consecutive method.

In an embodiment, the target pose of at least one constituent of the complex as received in step (b2) may differ from the starting pose of said at least one constituent as received in step (a2). The molecular dynamics simulation of the perturbation step (c) may then further comprise exerting a supplemental force on one or more atoms or one or more groups of atoms of said at least one constituent of the complex such as to modify the pose of said constituent(s) to at least partly converge towards the target pose of said constituent(s).

Preferably, backbone conformation of constituent molecule(s) comprising backbone and side-chains may be identical or substantially identical between the starting and target molecular structures.

Whereas a complex as intended herein may include any number of constituents among which any number of constituent molecules that comprise a backbone and side-chains, a non-limiting example of a complex composed of two interacting molecules (denoted M and m) each comprising backbone and side-chains may be used to illustrate an operation of the present methods:

The present methods may generally involve a reiterative communication between a docking and side-chain packing simulation on the one hand and a molecular dynamics (MD) simulation on the other hand. The docking and side-chain packing simulation may suitably depart from the backbone conformation and optionally pose (translation, rotation) of molecules M and m, and generates a new molecular structure of the docked complex defining new side-chain conformations and a new pose of molecules M and m (the simulation typically does not change the backbone conformation of molecules M and m). This new molecular structure of the docked complex represents a ‘target’ structure (denoted as T).

Next, an MD simulation is run to converge a previously available ‘starting’ molecular structure (denoted as S) of the complex towards the target molecular structure T. To this end, the MD simulation is steered or guided by applying external or supplemental forces (i.e., forces not derived from the native inter-atomic potentials, but generally exerted in function of the remoteness or closeness of a given variable, such as e.g. an atomic coordinate or a dihedral angle, from its desired value) to molecules M and m. In the present methods, said supplemental forces are primarily configured to converge the side-chain conformations of molecules M and m (e.g., as suitably defined by side-chain dihedral angles), and optionally and preferably the pose of molecules M and m, from their respective values in structure S to values in structure T.

The MD simulation is thus devised to at least partly “drag” or “pull” the starting structure S of the complex towards its target structure T. Importantly, in the course of the MD simulation the externally imposed forces and consequently structural changes (e.g., changes in the side-chain conformations and pose of molecules M and m) will induce conformational changes in the backbones of molecules M and m. Therefore, in contrast to conventional docking algorithms most of which do not foresee any adjustments to the backbones of docked constituents, the present methods by appropriately applying MD simulation comprising supplemental forces allow to examine changes that occur in backbones of interacting molecules (e.g., molecules M and m) upon formation of a complex.

Once the MD simulation has achieved some degree of convergence of the starting structure S towards the target structure T (such as, e.g., a predetermined degree of convergence, or convergence after a predetermined duration of the MD simulation), thereby generating a further molecular structure (denoted as I) of the complex, the MD simulation is halted and the resulting new backbone conformations and pose of molecules M and m are supplied to the docking and side-chain packing simulation to re-pack the side-chains and optimise the docking for said new backbone conformations of molecules M and m. This generates a yet further intermediate structure (denoted as I*).

At this stage the MD simulation can begin anew, wherein the structure I replaces the starting structure S and the structure I* replaces the target structure T. This establishes the reiterative character of the methods. The methods behave generally convergent, i.e., upon reiteration the structures I and I* tend to become progressively more similar to one another. To summarise, the present methods advantageously allow to analyse and model changes that may occur in backbones of interacting molecules (e.g., as explained for molecules M and m here above) upon formation of a complex. The method can thus provide more accurate structural information particularly for complexes whose constituents undergo significant conformational changes upon complex formation (e.g., induced fit binding).

In a further embodiment of the above aspect, the perturbation step (c) may be preceded by a step (b*): optimising the pose of the constituents of the complex by performing a molecular dynamics simulation on the starting molecular structure of the complex as received in step (a), wherein said constituents are restrained substantially towards their respective starting conformations (i.e., preferably towards the internal atomic coordinates of their starting conformations). The intermediate molecular structure of the complex so-generated by step (b*) is then acted upon by the perturbation step (c) instead of the starting molecular structure as received in step (a). This embodiment allows the perturbation step (c) to depart from a yet more optimised molecular structure of the complex, thereby further improving the predictive accuracy of our methods.

In this connection, the Applicant also realised the option of performing two embedded reiterative cycles, to further increase the predictive strength of the methods. In particular, a first cycle involves reiteration of the above-mentioned steps (b*), (c) and (d). Hence, the first cycle primarily relies on molecular dynamics and reiterates the sequence of: optimising the pose of the constituents in a complex, perturbing the so-optimised complex towards a target molecular structure thereof, and relaxing the so-perturbed complex. A second cycle involves reiteration of the above-mentioned steps (a), (b), [(b*), (c) and (d)] and (e), and thus reiteratively associates the first cycle [(b*), (c) and (d)] with a docking and side-chain packing simulation.

Reflecting this realisation, an embodiment provides a method for determining a molecular structure of a complex comprising two or more constituents, wherein one or more of said constituents is a molecule comprising backbone and side-chains, the method comprising:

(aa) receiving a starting molecular structure of said complex including receiving:
(aa1) starting conformations of said constituents; and
(aa2) starting pose of said constituents;
   (bb) receiving a target molecular structure of said complex including receiving:
(bb1) target conformations of said constituents, wherein one or more side-chain dihedral angles differ between the starting and target conformations of at least one of the constituent molecule(s) comprising backbone and side-chains; and
(bb2) target pose of said constituents;
   (cc) optimising the pose of the constituents of the complex by performing a molecular dynamics simulation on the starting molecular structure of the complex, wherein said constituents are restrained substantially towards their respective starting conformations (i.e., preferably towards the internal atomic coordinates of their starting conformations), thereby determining a first intermediate molecular structure of the complex;
   (dd) perturbing the first intermediate molecular structure of the complex by performing a molecular dynamics simulation thereon, thereby determining a second intermediate molecular structure of the complex, characterised in that the molecular dynamics simulation comprises exerting a supplemental force on one or more atoms or one or more groups of atoms of at least one of the constituent molecule(s) comprising backbone and side-chains such as to modify one or more side-chain dihedral angles of said molecule(s) to at least partly converge towards the corresponding side-chain dihedral angles of the target conformation of said molecule(s);
   (ee) relaxing the second intermediate molecular structure of the complex by performing a molecular dynamics simulation thereon without exerting said supplemental forces, thereby determining a third intermediate molecular structure of the complex;
   (ff) reiterating steps (cc) to (ee), wherein at each reiteration the third intermediate molecular structure of the complex determined in step (ee) is received in step (cc) instead of the starting molecular structure of the complex;
   (gg) following the last repetition of step (ff), supplying the third intermediate molecular structure to a docking and side-chain packing simulation, thereby determining a fourth intermediate molecular structure of the complex;
   (hh) reiterating steps (aa) to (gg), wherein at each reiteration the third intermediate molecular structure of the complex, as determined following the last repetition of step (ff), is received in step (aa) as the starting molecular structure of the complex, and the fourth intermediate molecular structure of the complex determined in step (gg) is received in step (bb) as the target molecular structure of the complex; and
   (ii) optionally and preferably, outputting data comprising information on a molecular structure of the complex as determined in any of the preceding steps, to a data storage medium or to a consecutive method.

In an embodiment, the target pose of at least one constituent of the complex as received in step (bb2) may differ from the starting pose of said at least one constituent as received in step (aa2). The molecular dynamics simulation of the perturbation step (dd) may then further comprise exerting a supplemental force on one or more atoms or one or more groups of atoms of said at least one constituent of the complex such as to modify the pose of said constituent(s) to at least partly converge towards the target pose of said constituent(s).

Preferably, backbone conformation of constituent molecule(s) comprising backbone and side-chains may be identical or substantially identical between the starting and target molecular structures.

Whereas methods as recited in the preceding aspects and embodiments reiterate certain method steps to more closely approximate the molecular structure of complexes, it shall be understood that methods and method steps sequences (modules) which do not involve or only partly involve said reiteration also to at least some extent produce the advantages explained herein, such as for example when run standalone, or within or in cooperation with other molecular structure analysis processes.

In view hereof, the invention thus also relates to:
A method for determining a molecular structure of a complex comprising two or more constituents, wherein one or more of said constituents is a molecule comprising backbone and side-chains, the method comprising the steps (a) (including sub-steps a1 and a2), (b) (including sub-steps b1 and b2), (c), (d), (e) and (g) as taught above, and optionally step (b*) as taught above introduced between steps (b) and (c). This method or module includes the MD simulation as well as the docking and side-chain packing simulation, but need not reiteratively combine said simulations, because it may leave out the step (f) which would otherwise impose reiteration on said steps (a) to (e).
A method for determining a molecular structure of a complex comprising two or more constituents, wherein one or more of said constituents is a molecule comprising backbone and side-chains, the method comprising the steps (aa) (including sub-steps aa1 and aa2), (bb) (including sub-steps bb1 and bb2), (cc), (dd), (ee), (ff), (gg) and (ii) as taught above. This method or module includes the MD simulation as well as the docking and side-chain packing simulation, and preserves the step (ff) which imposes reiteration on the MD simulation steps (cc) to (ee). However, it need not reiteratively combine the MD simulation with the docking and side-chain packing simulation, since it may leave out the step (hh) which would otherwise impose reiteration on said steps (aa) to (gg).
A method for determining a molecular structure of a complex comprising two or more constituents, wherein one or more of said constituents is a molecule comprising backbone and side-chains, the method comprising the steps (a) (including sub-steps a1 and a2), (b) (including sub-steps b1 and b2), (c), (d) and (g) as taught above, and optionally step (b*) as taught above introduced between steps (b) and (c). This method or module includes the MD simulation but need not include the docking and side-chain packing simulation nor involve reiteration, since it may leave out the steps (e) and (f). Advantageously, the (non-reiterative) MD simulation of this method or module still allows to induce some backbone conformation changes in complex constituents.
A method for determining a molecular structure of a complex comprising two or more constituents, wherein one or more of said constituents is a molecule comprising backbone and side-chains, the method comprising the steps (aa) (including sub-steps aa1 and aa2), (b) (including sub-steps bb1 and bb2), (cc), (dd), (ee), (ff) and (ii) as taught above. This method or module includes the MD simulation and preserves the step (ff) which imposes reiteration on the MD simulation steps (cc) to (ee). However, it need not include the docking and side-chain packing simulation and need not reiteratively combine the MD simulation with the docking and side-chain packing simulation, since it may leave out the steps (gg) and (hh). Advantageously, the reiterative MD simulation of this method or module still allows to induce some backbone conformation changes in complex constituents.

In any of the preceding methods or modules, the target pose of at least one constituent of the complex as received in step (b2) or (bb2) may differ from the starting pose of said at least one constituent as received in step (a2) or (aa2), respectively. The MD simulation of the perturbation step (c) or (dd), respectively, may then further comprise exerting a supplemental force on one or more atoms or one or more groups of atoms of said at least one constituent of the complex such as to modify the pose of said constituent(s) to at least partly converge towards the target pose of said constituent(s).

One shall appreciate that the outcome of the above methods or modules may generally include information about the conformation (e.g., backbone conformation and preferably also side-chain conformation) and preferably pose of those constituent molecule(s) of the complex which comprise backbone and side-chains. Hence, the above statements of the purpose of the present methods shall also encompass that the methods may be for determining the conformation and preferably pose of one or more molecules comprising backbone and side-chains, said molecule(s) being comprised in a complex.

Additionally, the present invention also broadly conceives of a method for determining a conformation of a molecule comprising a backbone and side-chains, said method comprising:

(aaa) receiving a starting conformation of said molecule, and optionally receiving a starting pose of said molecule;
(bbb) receiving a target conformation of said molecule, wherein one or more side-chain dihedral angles differ between said starting and target conformations, and optionally receiving a target pose of said molecule;
(ccc) perturbing the starting conformation by performing a molecular dynamics simulation thereon, thereby determining a first intermediate conformation of said molecule, characterised in that the molecular dynamics simulation comprises exerting a supplemental force on one or more atoms or one or more groups of atoms of said molecule such as to modify one or more side-chain dihedral angles of said molecule to at least partly converge towards the corresponding side-chain dihedral angles of said target conformation of the molecule;
(ddd) relaxing said first intermediate conformation by performing a molecular dynamics simulation thereon without exerting said supplemental forces, thereby determining a second intermediate conformation of said molecule; and
(eee) optionally and preferably, outputting data comprising information on a conformation of said molecule as determined in any of the preceding steps, to a data storage medium or to a consecutive method.

In an embodiment, the target pose of the molecule as optionally received in step (bbb) may differ from the starting pose of said molecule optionally received in step (aaa). The molecular dynamics simulation of the perturbation step (ccc) may then further comprise exerting a supplemental force on one or more atoms or one or more groups of atoms of said molecule such as to modify the pose of said molecule to at least partly converge towards the target pose of said molecule.

This method or module makes use of the Applicant's realisation that guided MD simulation may be employed to model the effect of distinct side-chain conformations or poses of a molecule on its backbone.

In an embodiment, this method or module may further (reiteratively or not reiteratively) cooperate with a side-chain packing simulation to yet more closely predict the effect of side-chain conformation on the backbone of the molecule. To this end, the method may further comprise step (ddd*), and optionally and preferably also an ensuing step (ddd**), inserted between the above steps (ddd) and (eee), as follows:

(ddd*) supplying the second intermediate conformation of the molecule to a side-chain packing simulation, thereby determining a third intermediate conformation of the molecule;
(ddd**) reiterating steps (aaa) to (ddd*), wherein at each reiteration the second intermediate conformation of the molecule determined in step (ddd) is received in step (aaa) as the starting conformation of the molecule, and the third intermediate conformation of the molecule determined in step (ddd*) is received in step (bbb) as the target conformation of the molecule.

Preferably, backbone conformation of the molecule comprising backbone and side-chains may be identical or substantially identical between the starting and target molecular conformations.

A further advantageous property of the herein disclosed methods is that they allow for more informative modelling of certain conditions extrinsic to the modelled molecule or complex, such as for example the presence or absence of solvent(s) or the nature of the solvent(s). In contrast to conventional docking and side-chain packing methods which usually ignore extrinsic influences, the inclusion of an MD simulation component in the present methods allows to consider such extrinsic effects on the molecular structure or conformation of the modelled complex or molecule, such as for example allows to consider solvent effects on said structure or conformation.

By means of example and not limitation, in distinct embodiments the MD simulation may be performed ‘in vacuum’ (i.e., without a solvent), or may be performed in the presence of an ‘implicit solvent’ such as ‘implicit water’ (i.e., wherein solvent effects are approximated by a potential energy equation in the MD simulation), or may be performed in the presence of ‘explicit solvent’ such as ‘explicit water’ (i.e., wherein the solvent molecules are defined in the MD simulation).

The invention further provides a computing device such as a computer configured for performing the present methods, i.e., for determining the molecular structure of a complex comprising two or more constituents, wherein one or more of said constituents is a molecule comprising backbone and side-chains, and/or for determining a conformation of a molecule comprising a backbone and side-chains, wherein the computing device comprises a plurality of means in a functional arrangement, each means configured to perform or effect an action required by a step of any one method or module set forth in the above aspects and embodiments, whereby the computing device is configured to perform said any one method or module.

In various embodiments the computing device may comprise a plurality of means, each means for (i.e., configured to perform or effect an action required by) a step of any one of the following methods or modules (the steps are denoted as taught above):
(a) (including sub-steps a1 and a2), (b) (including sub-steps a1 and a2), (b*) (optional), (c), (d), (e), (f) and (g);
(a) (including sub-steps a1 and a2), (b) (including sub-steps b1 and b2), (b*) (optional), (c), (d), (e) and (g);
(a) (including sub-steps a1 and a2), (b) (including sub-steps b1 and b2), (b*) (optional), (c), (d) and (g);
(aa) (including sub-steps aa1 and aa2), (bb) (including sub-steps bb1 and bb2), (cc), (dd), (ee), (ff), (gg), (hh) and (ii);
(aa) (including sub-steps aa1 and aa2), (bb) (including sub-steps bb1 and bb2), (cc), (dd), (ee), (ff), (gg) and (ii);
(aa) (including sub-steps aa1 and aa2), (bb) (including sub-steps bb1 and bb2), (cc), (dd), (ee), (ff) and (ii); or
(aaa), (bbb), (ccc), (ddd), (ddd*) (optional), (ddd**) (optional, only when ddd* is present) and (eee);

The invention further provides a program (i.e., a sequence of coded instructions executable by a mechanism such as a computing device; i.e., a software, a software product), wherein said program is configured to execute any one or more of the above taught methods or modules on a computing device such as a computer.

The program may suitably specify instructions for a computing device to perform or effect actions required by the steps of any one method or module set forth in the above aspects and embodiments. In exemplary embodiments the program may specify instructions to perform or effect actions required by any one of the following methods or modules (the steps are denoted as taught above):
(a) (including sub-steps a1 and a2), (b) (including sub-steps a1 and a2), (b*) (optional), (c), (d), (e), (f) and (g);
(a) (including sub-steps a1 and a2), (b) (including sub-steps b1 and b2), (b*) (optional), (c), (d), (e) and (g);
(a) (including sub-steps a1 and a2), (b) (including sub-steps b1 and b2), (b*) (optional), (c), (d) and (g);
(aa) (including sub-steps aa1 and aa2), (bb) (including sub-steps bb1 and bb2), (cc), (dd), (ee), (ff), (gg), (hh) and (ii);
(aa) (including sub-steps aa1 and aa2), (bb) (including sub-steps bb1 and bb2), (cc), (dd), (ee), (ff), (gg) and (ii);
(aa) (including sub-steps aa1 and aa2), (bb) (including sub-steps bb1 and bb2), (cc), (dd), (ee), (ff) and (ii); or
(aaa), (bbb), (ccc), (ddd), (ddd*) (optional), (ddd**) (optional, only when ddd* is present) and (eee);

The invention further relates to a computer-readable storage medium storing the program as taught herein.

The methods and modules disclosed herein, and computer devices and programs implementing such, may be applicable in numerous areas where the study of molecular conformation and intermolecular interactions is of relevance.

In an embodiment, molecule(s) comprising backbone and side-chains as intended herein may encompass biomolecules, such as preferably proteins, polypeptides and peptides.

In embodiments, the present methods and modules, computer devices and programs may thus be employed to study interactions of proteins and polypeptides with other molecules, such as inter alia with other proteins and polypeptides (protein-protein interactions), peptides (protein-peptide interactions), non-protein biomolecules (e.g., protein-lipid, protein-nucleic acid, protein-substrate, protein-metabolite or protein-messenger interactions, etc.), and other non-protein ligands (e.g., protein-small molecule interactions, e.g., protein-inhibitor interactions, etc.). Analysis of protein-protein interactions may be used inter alia to evaluate antigen-antibody binding, organisation of oligomeric or multimeric protein complexes such as for example enzymatic, structural or regulatory complexes, hormone-receptor interactions, cytokine-receptor interactions, etc. In embodiments, detailed information about how complex constituents interact may be used to modulate said interaction, such as for example by altering the structure of one or more of said constituents (e.g., protein engineering, drug design) or by designing molecule able to interfere with said interaction (e.g., drug design).

Accordingly, the invention also relates to information about or prediction of or model of the molecular structure of a complex comprising two or more constituents, wherein one or more of said constituents is a molecule comprising backbone and side-chains, as well as to information about or prediction of or model of the conformation of a molecule comprising a backbone and side-chains, as obtainable or directly obtained by the methods taught herein, to databases containing such information, prediction, or model, and to downstream uses (e.g., as above) of such information, prediction, or model.

These and further aspects and preferred embodiments of the invention are described in the following sections and in the appended claims. The subject matter of appended claims 1 to 20 is hereby specifically incorporated in this specification.

### BRIEF DESCRIPTION OF FIGURES

FIG. 1 illustrates the crystal structure of the 1 MEL complex before simulation.

FIG. 2 illustrates the 1MEL complex following simulation.

### DETAILED DESCRIPTION OF THE INVENTION

As used herein, the singular forms “a”, “an”, and “the” include both singular and plural referents unless the context clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or method steps.

The recitation of numerical ranges by endpoints includes all numbers and fractions subsumed within the respective ranges, as well as the recited endpoints.

The term “about” as used herein when referring to a measurable value such as a parameter, an amount, a temporal duration, and the like, is meant to encompass variations of and from the specified value, in particular variations of +/−10% or less, preferably +/−5% or less, more preferably +/−1% or less, and still more preferably +/−0.1% or less of and from the specified value, insofar such variations are appropriate to perform in the disclosed invention. It is to be understood that the value to which the modifier “about” refers is itself also specifically, and preferably, disclosed.

All documents cited in the present specification are hereby incorporated by reference in their entirety.

Unless otherwise defined, all terms used in disclosing the invention, including technical and scientific terms, have the meaning as commonly understood by one of ordinary skill in the art to which this invention belongs. By means of further guidance, term definitions may be included to better appreciate the teaching of the present invention.

The present methods and modules for determining conformation of molecules and/or molecular structure of complexes are primarily computational in nature, i.e., involving computing. The methods may thus generally receive, manipulate and output suitable data structures representing (i.e., containing information about) the molecular conformation or structure of molecules or complexes, e.g., information about all or some aspects of said molecular conformation or structure. Variables that may be included in such data structures are known per se and may comprise among others atomic coordinates in a physical space (e.g., defined by a 3-D coordinate system), bond lengths, dihedral angles, pose, or similar. Hence, the recitation “for determining” as used herein may be considered synonymous to “for generating information about”, e.g., in form of an appropriate data structure.

The term “complex” may generally denote an association (e.g., a comparably transient or permanent association) of two or more interacting constituents. A constituent may thus be involved in a complex through its interacting with one or more other constituents of said complex. Preferably, interactions between the constituents of a complex may be non-covalent, including primarily but without limitation van der Waals interactions, electrostatic (ionic) interactions, hydrogen bonds and/or hydrophobic packing. Preferably, a complex as intended herein may be a macromolecular complex.

In the present context, constituents of a complex may primarily encompass atoms and/or molecules.

Preferably, one or more constituents of a complex may be a biomolecule, e.g., a biological macromolecule, such as without limitation a peptide, polypeptide or protein, an oligonucleotide, polynucleotide or nucleic acid (e.g., DNA or RNA), an oligosaccharide or polysaccharide, a proteoglycan, or a lipid (e.g., a monoglyceride, diglyceride, phospholipid or sterol), more preferably a peptide, polypeptide or protein, even more preferably a polypeptide or protein. A reference herein to a biomolecule is to be understood as also encompassing derivatives and analogues of such biomolecule, such as inter alia chemical modifications (e.g., additions, omissions or substitutions of atoms and/or moieties) and/or biological modifications (e.g., post-production, post-transcription or post-expression modifications, e.g., phosphorylation, glycosylation, lipidation, methylation, cysteinylation, sulphonation, glutathionylation, acetylation, oxidation of methionine to methionine sulphoxide or methionine sulphone, and the like). A biomolecule as intended herein may but need not exist in nature, e.g., may be engineered de novo or engineered by altering a biomolecule known from nature, and may be obtainable by isolation or by synthetic, semi-synthetic or recombinant processes. Preferably, a biomolecule as intended herein may be biologically active.

The term “backbone” is synonymous with “backbone chain” or “main chain” as known in the art, and generally denotes a series of covalently bonded atoms that together create a continuous chain of a (oligomeric or polymeric) molecule, such as a biomolecule. By means of example, the backbone repeating unit of peptides, polypeptides and proteins may be denotes as (—NH—C_{α}H(−)—CO—)ₙ. A protein may comprise one or more backbone chains.

The term “side-chain” or “side-group” generally denotes a group or moiety of covalently bonded atoms linked to (i.e., extending or branching from) the backbone of a (oligomeric or polymeric) molecule. By means of example, in peptides, polypeptides and proteins, amino acid side chains are attached to the C_{α} carbon atoms of the backbone.

The present methods may advantageously utilise initial information about the conformation of molecules to be analysed, such as information about the conformation of molecules that may form a complex. Such information may be suitably available experimentally and/or computationally.

By means of example and not limitation, experimentally (e.g., using X-ray crystallography or NMR spectroscopy) resolved conformations of biomolecules and in particular many peptides, polypeptides, proteins, nucleic acids and complexes is published in scientific literature and compiled in public databases, such as notably the Protein Data Bank database (Berman et al. 2000. Nucleic Acids Res 28(1): 235-242; http://www.wwpdb.org/).

By means of example and not limitation, computational approaches for structure prediction of biomolecules and in particular peptides, polypeptides and proteins are widely available. For instance, these may comprise comparative protein modelling methods including homology modelling methods (see inter alia Marti-Renom et al. 2000. Annu Rev Biophys Biomol Struct 29: 291-325) performable without limitation using the ‘Modeller’ computer program (Fiser and Sali 2003. Methods Enzymol 374: 461-91) or the ‘Swiss-Model’ application (Arnold et al. 2006. Bioinformatics 22: 195-201); or protein threading modelling methods (see inter alia Bowie et al. 1991. Science 253: 164-170; Jones et al. 1992. Nature 358: 86-89) performable without limitation using the ‘HHsearch’ program (Söding 2005. Bioinformatics 21: 951-960), the ‘Phyre’ application (Kelley and Sternberg. 2009. Nature Protocols 4: 363-371) or the ‘Raptor’ program (Xu et al. 2003. J Bioinform Comput Biol 1: 95-117); may further comprise ab initio or de novo protein modelling methods using various algorithms, performable without limitation using the publically distributed ‘Rosetta’ platform (Simons et al. 1999. Genetics 37: 171-176; Baker 2000. Nature 405: 39-42; Bradley et al. 2003. Proteins 53: 457-468; Rohl 2004. Methods in Enzymology 383: 66-93), the ‘I-TASSER’ application (Wu et al. 2007. BMC Biol 5: 17), or using physics-based prediction (see inter alia Duan and Kollman 1998. Science 282: 740-744; Oldziej et al. 2005. Proc Natl Acad Sci USA 102: 7547-7552); or a combination of any such approaches. Computational approaches applicable herein for structure prediction of biomolecules are evaluated annually within the Critical Assessment of Techniques for Protein Structure (CASP) experiment as published in the CASP Proceedings (http://predictioncenter.org/). Advantageously, data holding information about computationally predicted conformations and structures of many biomolecules such as peptides, polypeptides and proteins are available through respective publically available repositories (see inter alia Kopp and Schwede 2004. Nucleic Acids Research 32, D230-D234).

Alongside the conformation of individual constituents of a complex, information about the molecular structure of the complex suitably further includes information concerning the pose of said constituents. The term “pose” generally refers to the translational and rotational degrees of freedom of an object (such as a constituent of a complex as intended herein) in a given space, e.g., in a 3-dimensional physical space the pose of an object may refer to the 3 translational and 3 rotational degrees of freedom of the object. The pose of an object may thus be expressed in terms of the object's position and orientation in a space, e.g., vis-à-vis a suitable coordinate system anchored in said space. By means of example, our methods may define the pose of constituents of a complex in absolute terms, i.e., as the constituents' position and orientation vis-à-vis a chosen coordinate system, or in relative terms, i.e., as the constituents' translation and rotation relative to one another. Notably, in a data structure the information about the pose of constituents may but need not be discrete from information about the conformation of the constituents. For example, depending on a chosen coordinate system, atomic coordinate values characterising the conformation of constituents may already inherently carry information about the pose of the constituents in said coordinate system.

Certain steps of our methods perform docking and/or side-chain packing simulations. The term “docking” generally denotes a computational process of assembling two or more separate constituents into a complex structure. The term “side-chain packing” or “side-chain positioning” generally denotes a computational process of predicting side-chain geometries for known backbone conformations, preferably identifying minimum energy side-chain conformations.

By means of example and not limitation, computational approaches for docking of molecules particularly involving one or more biomolecules and more particularly involving one or more peptides, polypeptides or proteins are widely available. For instance, such approaches may encompass rigid-body docking, semi-rigid-body docking or flexible docking methods, employing various algorithms to sample the available complex molecular structures (such as, e.g., Monte Carlo or reciprocal space algorithms), and ranking the sampled complex molecular structures using scoring functions known per se (such as, e.g., scoring functions based on residue contacts, on shape and/or chemical complementarity, force field scoring functions, empirical scoring functions, knowledge-based scoring functions, etc. or hybrid scoring functions combining such) (see inter alia Smith and Sternberg 2002. Curr Opin Struct Biol 12: 28-35; Camacho and Vajda 2002. Curr Opin Struct. Biol 12: 36-40; Halperin et al. 2002. Proteins: Struct Funct Genet 47: 409-443). Molecular docking may be performable without limitation using methods and applications participating in the Critical Assessment of Prediction of Interactions (CAPRI) initiative (Janin et al. 2003. Proteins 52 (1): 2-9; Méndez et al. 2005. Proteins 60: 150-169; http://www.ebi.ac.uk/msd-srv/capri/), such as inter alia the ‘RosettaDock’ (Gray et al. 2003. J Mol Biol 331: 281-99), ‘ClusPro’ (Comeau et al. Bioinformatics 20: 45-50), ‘GRAMM-X’ (Tovchigrechko and Vakser. 2006. Nucleic Acids Res 34: W310-4), ‘FireDock’ (Andrusier et al. 2007. Proteins 69: 139-59), ‘HADDOCK’ (Dominguez et al. 2003: J Am Chem Soc 125: 1731-1737), ‘PatchDock’ (Schneidman-Duhovny et al. 2005. Nucl Acids Res 33: W363-367), ‘SKE-DOCK’ (Genki Terashi et al. 2005. Proteins 60: 289-95), ‘3D-Garden’ (Lesk and Sternberg. 2008. Bioinf: doi: 10.1093/bioinformatics/btn093) and ‘Topdown’ methods and applications.

In a preferred embodiment, docking simulations in our methods may be performed using the RosettaDock method and program.

By means of example and not limitation, computational approaches for side-chain packing of molecules particularly biomolecules and more particularly peptides, polypeptides or proteins are widely available (see inter alia Voigt et al. 2000. J Mol Biol 299: 789-803). For instance, such approaches may encompass Monte Carlo (MC) and Monte Carlo plus quench (MCQ) methods (see inter alia Kuhlman and Baker 2000. Proc Natl Acad Sci USA 97: 10383-10388), genetic algorithms (GA), simulated annealing methods, restricted combinatorial analysis methods, self-consistent mean field (SCMF) methods, graph theory-based methods (Canutescu et al. 2003. Protein Sci 12: 2001-2014), dead-end elimination (DEE) methods (Desmet et al. 1992. Nature 356: 539-542; Pierce et al. 2000. J Comput Chem 21: 999-1009), and ‘fast and accurate side-chain topology and energy refinement’ (FASTER) methods (Desmet et al. 2002. Proteins 48: 31-43; WO 01/33438), or combinations thereof. Where applicable, side-chain rotamer choices in such methods may be sampled from suitable backbone-independent or preferably backbone-dependent rotamer libraries, such as, e.g., described by Dunbrack and Karplus 1993 (J Mol Biol 230: 543-571) and Dunbrack and Cohen 1997(Protein Sci 6: 1661-1681).

In a preferred embodiment, side-chain packing simulations in our methods may be performed using the ‘RosettaDock’ method and program. In another preferred embodiment, side-chain packing simulations in our methods may be performed using the SCWRI; method and program (see Bower et al. 1997. J Mol Biol 267: 1268-1282 and Canutescu et al. 2003. Protein Sci 12: 2001-2014).

The docking and side-chain packing simulations may be performed by distinct computational methods, or preferably the same computational method may be configured to perform both docking and side-chain packing simulations, simultaneously or sequentially in any suitable order (such as, e.g., ‘RosettaDock’).

Steps of our methods including docking and/or side-chain packing simulations can suitably employ information about the backbone conformation of constituents of a complex and preferably an initial pose of said constituents in the complex (e.g., where the constituents have been docked in an earlier step), and apply docking and/or side-chain packing simulations to said information, thereby generating information about side-chain conformations and (changed) pose of the constituents in the complex. Where a step of our methods stipulates performing a docking and side-chain packing simulation, this may involve performing one or more docking simulations and one or more side-chain packing simulations in any suitable order, and may also involve a plurality of parallel and/or reiterative cycles performing a suitable sequence of one or more docking simulations and one or more side-chain packing simulations, and optionally selecting the best scoring resulting molecular structure.

In a preferred embodiment, a step including a docking and side-chain packing simulation may comprise: (1) receiving backbone conformations of constituents of a complex and preferably initial pose of said constituents in the (previously docked) complex; (2) adding side-chains to the backbones of said constituents using a side-chain packing simulation; and (3) optimising docking of said constituents with added side-chains using a docking simulation, thereby generating information about a molecular structure of the complex. These steps form the basis of the docking and side-chain packing simulation of the ‘RosettaDock’ method as described by Gray et al. 2003 (J Mol Biol 331(1): 281-99), and the use of the ‘RosettaDock’ method and its preferred settings is specifically contemplated herein. The step (2) may preferably take into account external influences, such as inter alia interface residue-residue interactions and residue-environment (e.g., residue-solvent) interactions, on side-chain packing. The step (3) may preferably take into account external influences, such as inter alia interface residue-residue interactions and residue-environment (e.g., residue-solvent) interactions, on constituent docking. Optionally, the steps (1) to (3) may be repeated while inserting an additional step (1*) in between the steps (1) and (2), wherein said step (1*) introduces a random or controlled change in the pose of the constituents (e.g., a translations of mean about 0.1 A° in each direction of a Cartesian space and rotations of mean about 0.05° around each Cartesian axis). This allows to generate in the step (3) a number of alternative molecular structures of the complex (e.g., about 50 alternatives) while starting from the same data set in step (1), thereby more exhaustively sampling the possible molecular structures of the complex. A best scoring (e.g., lowest energy) molecular structure may be selected for downstream steps. By means of example, the step (2) may use simulated-annealing Monte Carlo search for optimal combination of rotamers and/or the step (3) may use a rigid-body docking algorithm. In an alternative, the order of the steps (2) and (3) may be reversed, i.e., first the docking is optimised based on backbones (optionally wherein side-chains are represented by centroid positions) and then adding explicit side-chains.

The present methods further include steps in which molecules and complexes are evaluated using molecular dynamics (MD) simulations. This particularly concerns the ‘pose optimisation’ or ‘docking optimisation’ steps denoted above as (b*) and (cc), the ‘perturbation’ steps denoted above as (c), (dd) and (ccc), and the ‘relaxation’ steps denoted above as (d), (ee) and (ddd).

The term “molecular dynamics” (MD) generally denotes computational simulation methods in which the time evolution of a set of interacting atoms, groups of atoms or molecules is followed by integrating their equations of motion. Typically, MD simulations rely on the laws of classical mechanics, but MD simulations incorporating principles of quantum mechanics and hybrid classical-quantum mechanics simulations are also available and may be contemplated herein.

Principles of and methods for performing MD simulations are generally known in the art and need not be repeated herein, see inter alia J M Haile, 1997, “Molecular Dynamics Simulation: Elementary Methods”, Wiley-Interscience, 1^{st} ed., ISBN: 047118439X; and DC Rapaport, 2004, “The Art of Molecular Dynamics Simulation”, Cambridge University Press; 2^{nd} ed., ISBN: 0521825687.

Numerous computational methods and programs for performing MD simulations are available and may be used herein, such as without limitation, the ‘GROMACS’ program (see inter alia Lindahl et al. 2001. Journal of Molecular Modeling 7: 306-317; Van Der Spoel et al. 2005. J Comput Chem 26: 1701-18; and Hess et al. 2008. J Chem Theory Comput 4: 435); ‘GROMOS’ program (see inter alia van Gunsteren et al., 1996, “Biomolecular Simulation: The GROMOS96 Manual and User Guide”, Vdf Hochschulverlag AG an der ETH Zürich, Zürich, Switzerland, pp. 1-1042); ‘AMBER’ program (see inter alia Case et al. 2005. J Computat Chem 26: 1668-1688; and Case et al., 2008, “AMBER 10”, University of California, San Francisco); and ‘CHARMM’ program (see inter alia Brooks et al. 1983. J Comp Chem 4: 187-217; and MacKerell et al., 1998, “CHARMM: The Energy Function and Its Parameterization with an Overview of the Program”, in The Encyclopedia of Computational Chemistry, 1^{st} ed., John Wiley & Sons: Chichester, pp. 271-277).

In a preferred embodiment, MD simulation in our methods may be performed using the ‘GROMACS’ method and program.

To calculate forces exerted by and among the members of a simulated system (e.g., atoms, groups of atoms or molecules), such as particularly in function of the distance, properties (e.g., charge, polarisability, etc.) and relation (e.g., bound or unbound) of said members, MD methods and programs commonly employ potential functions or “force fields”, including without limitation empirical potentials, semi-empirical potentials, polarisable potentials, pair potentials, many-body potentials, etc.

A multitude of force fields for MD simulations are available and can be used herein, and the potential terms thereof need not be repeated herein (see for example Guvench and MacKerell 2008. “Comparison of protein force fields for molecular dynamics simulations”. Methods Mol Biot 443: 63-88). Without limitation, these include ‘GROMACS’ force fields particularly developed for the ‘GROMACS’ program (see inter alia the references above); ‘GROMOS’ force fields (see inter alia Schuler et al. 2001. Journal of Computational Chemistry 22: 1205-1218); ‘AMBER’ force fields (see inter alia Ponder and Case. 2003. Adv Prot Chem 66: 27-85); and ‘CHARMM’ force fields (see inter alia MacKerell et al. 1998. J Phys Chem B 102: 3586-3616; MacKerell et al. 2004. J Comput Chem 25: 1400-1415; Brooks et al. 2006. J Am Chem Soc 128: 3728-3736; and MacKerell et al. 2001. Biopolymers 56: 257-265).

In a preferred embodiment, MD simulation in our methods may employ the ‘GROMACS’ force field, more preferably in conjunction with the ‘GROMACS’ MD method and program.

As explained, in some steps of the present methods an MD simulation may comprise ‘pulling’ or ‘dragging’ of a starting conformation of a molecule or molecular structure of a complex towards a different, target conformation of said molecule or molecular structure of said complex. For example, in steps denoted above as (c) and (dd) the starting and target molecular structures of the complex may differ in one or more side-chain dihedral angles of one or more constituents of the complex, and potentially in the pose of one or more constituents of the complex. For example, in step denoted above as (ccc) the starting and target conformations of the molecule may differ in one or more side-chain dihedral angles of said molecule.

The term “dihedral angle” has an established meaning in geometry and stereochemistry and generally refers to the angle between two intersecting planes on a third plane normal to the intersection of the two planes. Hence, a chain of atoms A¹-A²-A³-A⁴ defines a dihedral angle, i.e., the angle between the plane containing the atoms A¹-A²-A³ and the plane containing the atoms A²-A³-A⁴. Reference to a “side-chain dihedral angle” or “side-chain dihedral” may generally encompass dihedral angles defined by any chain of four atoms in which two or more of said atoms belong to a side-chain. For example, the side-chain conformation of peptides, polypeptides and proteins can be traditionally described in terms of side-chain dihedral angles denoted as χ(chi), wherein the dihedral angle defined by atoms N-Cα-Cβ-Cγ is denoted as χ₁, the dihedral angle defined by atoms Cα-Cβ-Cγ-Cδ is denoted as χ₂, and so on. Hence, the side-chain conformation of most amino acid residues in peptides, polypeptides and proteins may be suitably defined in terms of none (e.g., Ala, Gly) to five (e.g., Arg) side-chain dihedrals (χ₁ to χ₅).

To impose a certain overall direction of a structural change of a molecule or complex during an MD simulation, the present methods supplement force fields used in MD simulations with additional (i.e., supplemental or external) forces, which can ‘pull’ or ‘drag’ atoms or groups of atoms from their respective positions in a starting molecular structure of a molecule or complex towards their respective positions in the intended, target molecular structure. Hence, the supplemental forces incorporate a ‘pull’ or ‘drag’ on atoms or groups of atoms generally consistent with the intended direction and extent of the structural change (e.g., change of side-chain dihedrals and/or change of pose). These forces may be suitably denoted as supplemental (i.e., additional or external) since they generally do not derive form the intrinsic, mutual interactions and influences between the members (e.g., atoms, groups of atoms or molecules) of an MD-simulated system, but instead impose additional, externally postulated desirables or objectives on the MD-simulated system.

Advantageously, supplemental forces may be imposed on an MD-simulation through suitable restraints, such as preferably any one or more or all of dihedral restraints, position restraints including linear position restraints and/or harmonic position restraints, and conformational restraints, simultaneously or sequentially in any suitable order. Preferably, the ‘perturbation’ steps denoted above as (c), (dd) and (ccc) may primarily apply dihedral restraints and where appropriate also linear position restraints.

The term “restraint” as used herein generally encompasses placing a restriction or preference or guiding directive on the position of a member (e.g., an atom, group of atoms or molecule) of an MD-simulated system. For example, the restrained or preferred position of a member may be stipulated as an absolute coordinate (value or range) vis-à-vis a chosen coordinate system, or as a coordinate (value or range) relative to one or more other members of the system.

To modify a given dihedral angle, the present methods may exert a supplemental force on the fourth atom defining said dihedral, in a tangential direction. For example, to modify a given χ₁ dihedral, a tangential force would be exerted on the corresponding side-chain Cγ atom.

By means of example, side-chain dihedrals may be computed for and compared between starting and target molecular structures of a molecule or complex, yielding for each side-chain dihedral the difference (Δ_{DIH}) between its value in the starting structure (starting value) and its value in the target structure (target value). Restraints can then be applied to ‘steer’ the dihedrals from their starting values towards their target values.

For example, a restraint may be configured to increase a tangential force on the fourth atom defining a given dihedral if Δ_{DIH} for said dihedral exceeds a set value, preferably exceeds about 10°. If Δ_{DIH} is less than the set value, the force may be lowered, e.g., progressively lowered to zero when Δ_{DIH} is 0, i.e., where target dihedral value is achieved. These settings avoid unnecessarily straining the simulated structure, since no or minimal supplemental forces are put on dihedrals which have or are close to their target values. If Δ_{DIH} is greater than 0° or greater than the set value, the force may be increased, e.g., progressively increased with increasing Δ_{DIH}, but may be configured to not exceed a set maximum force in order to not destabilise the simulated structure.

Alternatively and preferably, the dihedral constraints may be linear, i.e., the tangential force applied when Δ_{DIH} is greater than 0° or greater than a set value may be independent from the angular distance between the starting and target angle, i.e., independent from the magnitude of Δ_{DIH}. Optionally, for dihedrals whose Δ_{DIH} is greater than 0° or greater than a set value, the tangential force may also increase as a function of duration of the simulation, to accelerate the intended structural change (i.e., the tangential force constant k_{dihr}, may be variable, preferably may increase, more preferably linearly increase, as a function of duration of a simulation; for example k_{dihr}, may equal 0 at the outset of an active period of a simulation cycle and increase during said active period).

In another embodiment, said force may not increase as a function of duration of the simulation, but optionally the simulation time may be variable, e.g., to allow sufficient time for the dihedral change.

In further embodiments the force constant and/or increment of the supplemental force for modifying dihedral angles may be equal for all dihedral angles of a given side chain; or the force constant and/or increment of said supplemental force may be (progressively) greater for side-chain dihedral angles farther away from the backbone; or the force constant and/or increment of said supplemental force may be (progressively) greater for side-chain dihedral angles closer to the backbone (this ensures a faster-converging dihedral close to the backbone, and can reduce inaccuracy at dihedrals farther away from the backbone).

MD methods and programs such as for example ‘GROMACS’ can impose harmonic position restraints, e.g., to maintain or bias the position of one or more members (e.g., atoms, groups of atoms or molecules) of a simulated system to a set value. Hence, when the position of a harmonically restrained member deviates from its set value, a correcting force is applied on the member, said force increasing proportionately with the magnitude of the deviation, as illustrated by an exemplary potential function (Vₚᵣ) for a harmonic position restraint on atom i for reference position rᵢ:

Vₚᵣ(rᵢ)=½[−kₚᵣ^{x}(xᵢ−Xᵢ)²−kₚᵣ^{y}(yᵢ−Yᵢ)²−kₚᵣ^{z}(zᵢ−Zᵢ)²],

where kₚᵣ^{x}, kₚᵣ^{x} and kₚᵣ^{x} denote force constants in the respective coordinate directions, wherein the negative of a derivative of such potential function defines the correcting force exerted on such atom i along the respective coordinate axes:

Fᵢ^{x}=−kₚᵣ^{x}(xᵢ−Xᵢ)

Fᵢ^{y}=−kₚᵣ^{y}(yᵢ−Yᵢ)

Fᵢ^{z}=−kₚᵣ^{z}(zᵢ−Zᵢ)

Harmonic position restraints may be used in the present methods as needed, e.g., when an MD simulation should preferably not distort certain parts of a molecule (e.g., a backbone or backbone +C_{β} atoms).

However, harmonic position restraints are less suitable for ‘pulling’ or ‘dragging’ a given molecule from its starting pose towards its target pose, as may be required in the ‘perturbation’ steps denoted above as (c), (dd) and (ccc). In particular, in this situation the distances between the starting and target positions of atoms may be fairly large, resulting in excessive and heterogeneous forces which may lead to destabilisation of the molecule.

To solve this problem, the Applicant has devised a new type of restrains denoted herein as linear position restraints. In contrast to harmonic position restraints, the force applied on a restrained member by linear position restraints is not made proportional to the magnitude of said member's deviation from its intended, set position. Instead, the force is preferably held constant, as illustrated by the following exemplary potential function (Vₚᵣ) for a linear position restraint on atom i for reference position rᵢ:

Vₚᵣ(rᵢ)=kₚᵣ^{x}(xᵢ−Xᵢ)+kₚᵣ^{y}(yᵢ−Yᵢ)+kₚᵣ^{z}(zᵢ−Zᵢ),

where kₚᵣ^{x}, kₚᵣ^{y} and kₚᵣ^{z} denote force constants in the respective coordinate directions, wherein the negative of a derivative of such potential function defines the correcting force exerted on such atom i along the respective coordinate axes:

Fᵢ^{x}=−kₚᵣ^{x}

Fᵢ^{y}=−kₚᵣ^{y}

Fᵢ^{z}=−kₚᵣ^{z}

Accordingly, the force resulting from the application of linear position restraints on said atom ‘i’ is a vector of constant magnitude:

\sqrt{Fᵢ²x+Fᵢ²y+Fᵢ²z}=C

Our methods may advantageously use a further new kind of restraints denoted herein as conformational restraints. A conformational restraint is configured to restrain the relative position of a given member (e.g., atom, group of atoms or molecule) of a simulated system vis-à-vis the position of one or more other members of the system, while the absolute position of said member(s) is not restrained. Hence, conformational restraints may be alternatively denoted as relative position restraints.

Conformational restraints may be suitably realised through re-fitting the structure with which the restraints were initiated onto the restrained members as they are at each particular time interval of a simulation. Using harmonic position restraints as explained above the members are then pulled towards their respective fitted positions.

Conformational restraints may be advantageously used to substantially conserve the conformation of a simulated molecule or part thereof (e.g., backbone conformation of a molecule; or backbone +C_{β} atom conformation of a molecule) while otherwise acting on said molecule (e.g., translating and/or rotating the molecule). Conformational restraints may also be advantageously used to reduce the potentially destabilising effect of other restraints (e.g., harmonic or linear position restraints) on the molecule.

Distinct types of restraints may be particularly suited for different MD simulation steps of the present methods, and also two or more distinct restraints types may be applied simultaneously or sequentially in any order. Preferably, in the ‘pose optimisation’ or ‘docking optimisation’ steps denoted above as (b*) and (cc), the complex constituents are restrained substantially towards their starting conformations, e.g., towards the internal atomic coordinates of their respective starting conformations. This may be suitably achieved by applying conformational restraints on some, most or all atoms or groups of atoms of said constituents (e.g., both backbone and side-chain atoms may be conformationally restrained). Hereby, the MD simulation will sample the translational and rotational options of the constituents without allowing substantial conformational changes of said constituents.

Further preferably, the ‘perturbation’ steps denoted above as (c), (dd) and (ccc), may apply dihedral restraints in order to ‘steer’ side-chain dihedral angles towards their respective target values. Optionally, to reduce the extent of backbone change, harmonic position restrains may restrain backbone atoms (and potentially also C_{β} atoms) while said dihedral restraints are being applied to the side-chains. The ‘perturbation’ steps (c), (dd) and (ccc) may further apply linear position restraints in order to pull atoms or groups of atoms in molecules towards their target positions consistent with the respective target poses of said molecules. Optionally, to avoid destabilisation of the molecules, conformational restraints may be applied on some, most or all atoms or groups of atoms of said molecules (e.g., the backbone and optionally side-chain atoms may be conformationally restrained), while said linear position restraints are being applied. The ‘perturbation’ steps (c), (dd) and (ccc) may apply said dihedral restraints and linear position restraints simultaneously or sequentially in any order.

In a preferred embodiment, linear position restraints may be imposed first in order to ‘pull’ the molecules towards their respective target poses, and dihedral restraints may then be applied to ‘steer’ side-chain dihedral angles towards their respective target values. Preferably, in the ‘relaxation’ steps denoted above as (d), (ee) and (ddd) supplemental forces facilitated by the restraints applied in the preceding steps are not exerted. Particularly preferably, no linear position restraints and dihedral restraints are applied. More preferably, in said ‘relaxation’ steps no supplemental forces are exerted on the system, i.e., all forces derived from the supplementary force field are eliminated, such that the MD simulation is allowed to run its ‘conventional’ course to thermodynamically relax the molecular structure on the basis of the intrinsic influences and interactions between members of the simulated system.

In the present MD simulations each stage or step may be active until a predetermined criterion is met, such as, e.g., reaching a predetermined simulation time, obtaining a target molecular structure or a predetermined degree of convergence from a starting towards a target structure, or reaching a predetermined maximum force.

For example, the ‘pose optimisation’ or ‘docking optimisation’ steps denoted above as (b*) and (cc) may be preferably active for a predetermined duration of simulation time, e.g., may be configured to simulate between about 0.5 ps and about 500 ps, more preferably about 10 ps of real time.

For example, the ‘relaxation’ steps denoted above as (d), (ee) and (ddd) may be preferably active for a predetermined duration of simulation time, e.g., may be configured to simulate between about 0.5 ps and about 500 ps, more preferably about 10 ps of real time.

In an embodiment, the ‘perturbation’ steps denoted above as (c), (dd) and (ccc), or any sub-stages thereof applying distinct restraints, may be active for a predetermined duration of simulation time, e.g., may be configured to simulate between about 0.5 ps and about 500 ps, more preferably about 10 ps of real time.

In another embodiment, said ‘perturbation’ steps (c), (dd) and (ccc), or any sub-stages thereof applying distinct restraints, may be active until a target molecular structure is obtained or until a predetermined degree of convergence from a starting towards a target structure is obtained, as expressed, e.g., by average or sum difference between the side-chain dihedrals of the starting vs. target structure, and/or by average or sum difference between atom positions of the starting vs. target structure. Another predetermined degree of convergence can be advantageously established on the progress of the sum difference: if the target distance is not attained and summations stop decreasing, the convergence is deemed maximized and the next active cycle will not be entered.

The sequence of MD ‘pose optimisation’, ‘perturbation’ and ‘relaxation’ steps may be reiterated until a predetermined criterion is met, such as, e.g., reaching a predetermined number of reiterations or obtaining a predetermined degree of identity between molecular structures produced by two consecutive reiterations, or obtaining a predetermined quality of a predicted molecular structure (e.g., substantially no improvement of the structure).

By means of example, the number of reiterations may be between 1 and 100, such as about 10.

Further, the sequence of MD-driven steps plus docking and side-chain packing steps in the present methods may be reiterated until a predetermined criterion is met, such as, e.g., reaching a predetermined number of reiterations or obtaining a predetermined degree of identity between molecular structures produced by two consecutive reiterations, or obtaining a predetermined quality of a predicted molecular structure (e.g., substantially no improvement of the structure).

By means of example, the number of reiterations may be between 1 and 100, such as about 10.

In the present methods, the quality of a molecular conformation predicted in any one or more steps may be evaluated by calculating a potential or free energy value therefore using energy cost functions known per se.

For example, molecular dynamics simulations allow to calculate the free energy from the entire molecular system as described and controlled by the molecular dynamics Hamiltonian. This is particularly feasible for protein-protein interactions because the molecular system components are comparable in size. Another suitable option employing MD energies is to use the Linear Interaction Energy method, as disclosed in Journal of Computer-Aided Molecular Design 12: 27-35, 1998.

Further in the present methods, the quality of a molecular structure of a complex predicted in any one or more steps may be evaluated by criteria known per se, such as for example native contacts, ligand root-mean-square deviation (rmsd) and/or binding site rmsd, or by calculating interaction energy.

For example, rmsd of a predicted complex structure vis-à-vis an actual (experimentally determined) structure of said complex may be calculated as follows:

$$rmsd = \sqrt{{\sum }_{0}^{i} {[ {x}_{i} - {y}_{i} ]}^{2}}$$

wherein xᵢ and yᵢ are positions of the corresponding C_{α} atoms in the predicted and actual structures.

For example, interaction energy (E_{interaction}) may be calculated taking into account Leonard-Jones (LJ) and coulomb (C) interactions as follows:

$${E}_{interaction} = ( {E}_{LJ}^{receptor - ligand} + {E}_{C}^{receptor - ligand} ) - ( {E}_{LJ}^{ligand - solution} + {E}_{C}^{ligand - solution} ) - {E}_{LJ}^{receptor - solution} + {E}_{C}^{receptor - solution} )$$

As set out above, the present methods generally depart from an initial starting molecular structure and an initial target molecular structure of a molecule or a complex; subject said initial starting structure to MD simulations and side-chain packing and (where applicable) docking simulations; thereby producing intermediate structures which are entered as new starting and target structures in ensuing reiterations of the method steps.

Suitably, an initial starting molecular structure may be generated experimentally and/or predicted computationally and where available may be collected from a database or repository. An initial target molecular structure will differ from the initial starting molecular structure in one or more side-chain dihedrals and where applicable in the pose of one or more complex constituents. The initial target molecular structure may also be generated experimentally and/or predicted computationally and where available may be collected from a database or repository.

In a preferred example, the initial starting and target molecular structures of a complex may be generated from experimentally and/or computationally produced conformations of the constituents of the complex as follows: (1) the constituents are docked using a docking simulation; (2) the so-docked complex is subjected to a conventional MD simulation (without supplemental forces) and the resulting molecular structure is considered the initial starting molecular structure of the complex; (3) the molecular structure from step (2) is subjected to a docking and side-chain packing simulation, thereby providing an initial target molecular structure of the complex. These steps are analogously applicable to individual molecules.

Substantially any general-purpose computer may be configured to a functional arrangement for the methods and programs disclosed herein. The hardware architecture of such a computer can be realised by a person skilled in the art, and may comprise hardware components including one or more processors (CPU), a random-access memory (RAM), a read-only memory (ROM), an internal or external data storage medium (e.g., hard disk drive). The computer preferably comprises one or more graphic boards for processing and outputting graphical information to display means. Hereby, information about the progression and/or outcome of the present modelling methods may be advantageously displayed to a user, such as using conventional atom and molecule depiction principles. The above components may be suitably interconnected via a bus inside the computer. The computer may further comprise suitable interfaces for communicating with general-purpose external components such as a monitor, keyboard, mouse, network, etc. Preferably, may be capable of parallel processing or may be part of a network configured for parallel or distributive computing to increase the processing power for the present methods and programs.

Programs as intended herein for effecting the present methods may be created in any machine readable programming language, such as preferably but without limitation C or C++.

The object of the present invention may also be achieved by supplying a system or an apparatus with a storage medium which stores program code of software that realises the functions of the above-described embodiments, and causing a computer (or CPU or MPU) of the system or apparatus to read out and execute the program code stored in the storage medium.

In this case, the program code itself read out from the storage medium realizes the functions of the embodiments described above, so that the storage medium storing the program code also and the program code per se constitutes the present invention.

The storage medium for supplying the program code may be selected, for example, from a floppy disk, hard disk, optical disk, magneto-optical disk, CD-ROM, CD-R, magnetic tape, non-volatile memory card, ROM, DVD-ROM, Blue-ray disk, solid state disk, and network attached storage (NAS).

It is to be understood that the functions of the embodiments described above can be realised not only by executing a program code read out by a computer, but also by causing an operating system (OS) that operates on the computer to perform a part or the whole of the actual operations according to instructions of the program code.

Furthermore, the program code read out from the storage medium may be written into a memory provided in an expanded board inserted in the computer, or an expanded unit connected to the computer, and a CPU or the like provided in the expanded board or expanded unit may actually perform a part or all of the operations according to the instructions of the program code, so as to accomplish the functions of the embodiment described above.

It is apparent that there have been provided in accordance with the invention methods, programs, computing devices uses thereof that provide for substantial advantages as set forth above. While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as follows in the spirit and broad scope of the appended claims.

### EXAMPLES

### Example 1

The following sequence of steps schematically depicts a preferred embodiment of the methods according to the invention, using Rosetta docking and side-chain packing simulation program (in particular Rosetta bundle v. 2.2.0/subversion 19195) and GROMACS MD simulation program (in particular GROMACS v.3.3.1).

1) Input ‘current structure’ to Rosetta, run Rosetta to create n decoys (preferably only 1 decoy), select best scoring decoy.
2) If best scoring decoy from 1) is better than ‘current structure’, continue to step 3), otherwise repeat step 1).
3) Pass decoy selected in 1) to GROMACS as ‘target structure’.
4) Run GROMACS to converge ‘current structure’ towards ‘target structure’ thereby generating a ‘new current structure’, including:

Pull Phase
4.1) Apply linear position restraints and conformational restraints on all heavy atoms

Angle Phase
4.2) Remove restraints
4.3) Apply harmonic position restraints on heavy backbone and C_{β} atoms
4.4) Apply linear dihedral restraints on all dihedrals and increase tangential force during active cycle if:
   (target angle−current angle)>10 degrees
   (target region−current region)>0.66
   otherwise decrease force

Flexible or Relaxation Phase
4.5) Remove restraints
5) Pass ‘new current structure’ to step 1) as ‘current structure’.

Here above, heavy atoms particularly denote C, N, O and S atoms, whereas H atoms are not considered heavy. The target region refers to the local site at which the docking partner should be directed to. After entering this region, atomic contacts can be created and optimized.

### Example 2

Applying the method of Example 1, flexible backbone docking has been used to remodel the 1MEL complex comprising a Vₕ single domain antibody and lysozyme (Desmyter et al. 1996. Nat Struct Biol. 3: 803-11).

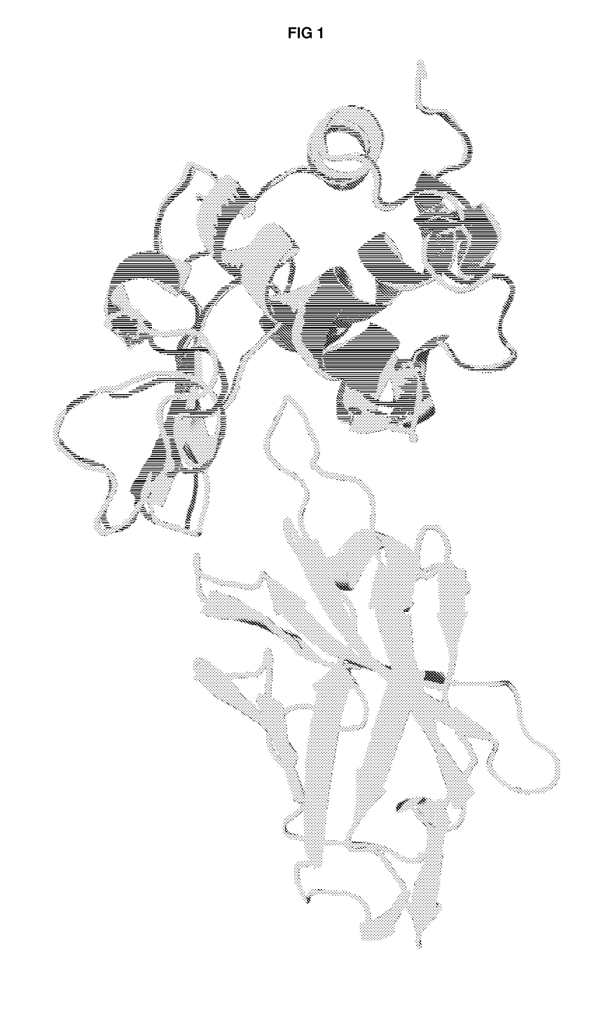

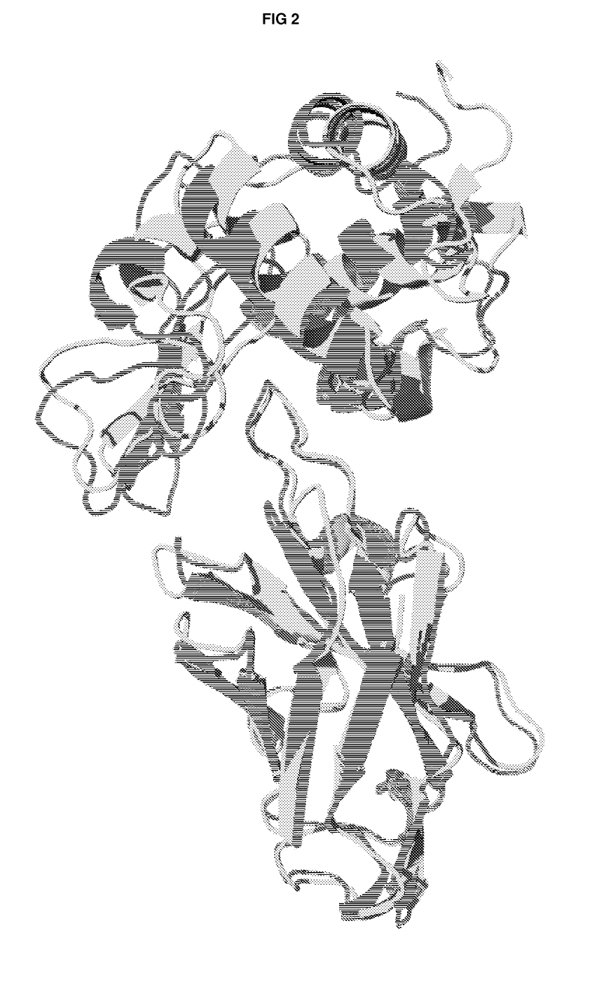

FIG. 1 shows the crystal structure of the 1MEL complex before simulation, i.e., where the ligand is not yet docked using the present method. FIG. 2 reproduces the final result after 240 ps simulation containing 480 active cycles, thereby achieving rmsd of 3.6 Å. In the figures, grey structures capture 1MEL crystal structure from the Protein Databank Brookhaven, and striped structures embody the simulated 1MEL protein complex.

1. A method for determining a molecular structure of a complex comprising two or more constituents, wherein one or more of said constituents is a molecule comprising backbone and side-chains, the method comprising:
(a) receiving a starting molecular structure of said complex including receiving:
(a1) starting conformations of said constituents; and
(a2) starting pose of said constituents;
(b) receiving a target molecular structure of said complex including receiving:
(b1) target conformations of said constituents, wherein one or more side-chain dihedral angles differ between the starting and target conformations of at least one of the constituent molecule(s) comprising backbone and side-chains; and
(b2) target pose of said constituents;
(c) perturbing the starting molecular structure of the complex by performing a molecular dynamics simulation thereon, thereby determining a first intermediate molecular structure of the complex, characterised in that the molecular dynamics simulation comprises exerting a supplemental force on one or more atoms or one or more groups of atoms of at least one of the constituent molecule(s) comprising backbone and side-chains such as to modify one or more side-chain dihedral angles of said molecule(s) to at least partly converge towards the corresponding side-chain dihedral angles of the target conformation of said molecule(s);
(d) relaxing the first intermediate molecular structure of the complex by performing a molecular dynamics simulation thereon without exerting said supplemental forces, thereby determining a second intermediate molecular structure of the complex;
(e) supplying the second intermediate molecular structure of the complex to a docking and side-chain packing simulation, thereby determining a third intermediate molecular structure of the complex;
(f) reiterating steps (a) to (e), wherein at each reiteration the second intermediate molecular structure of the complex determined in step (d) is received in step (a) as the starting molecular structure of the complex, and the third intermediate molecular structure of the complex determined in step (e) is received in step (b) as the target molecular structure of the complex; and
(g) optionally and preferably, outputting data comprising information on a molecular structure of the complex as determined in any of the preceding steps, to a data storage medium or to a consecutive method.

2. The method according to claim 1, wherein the target pose of at least one constituent of the complex as received in step (b2) differs from the starting pose of said at least one constituent as received in step (a2) and wherein the step (c) further comprises exerting a supplemental force on one or more atoms or one or more groups of atoms of said at least one constituent of the complex such as to modify the pose of said constituent(s) to at least partly converge towards the target pose of said constituent(s).

3. The method according to claim 1, wherein backbone conformation of constituent molecule(s) comprising backbone and side-chains is identical or substantially identical between the starting and target molecular structures.

4. A method for determining a molecular structure of a complex comprising two or more constituents, wherein one or more of said constituents is a molecule comprising backbone and side-chains, the method comprising:
(aa) receiving a starting molecular structure of said complex including receiving:
(aa1) starting conformations of said constituents; and
(aa2) starting pose of said constituents;
(bb) receiving a target molecular structure of said complex including receiving:
(bb1) target conformations of said constituents, wherein one or more side-chain dihedral angles differ between the starting and target conformations of at least one of the constituent molecule(s) comprising backbone and side-chains; and
(bb2) target pose of said constituents;
(cc) optimising the pose of the constituents of the complex by performing a molecular dynamics simulation on the starting molecular structure of the complex, wherein said constituents are restrained substantially towards their respective starting conformations, thereby determining a first intermediate molecular structure of the complex;
(dd) perturbing the first intermediate molecular structure of the complex by performing a molecular dynamics simulation thereon, thereby determining a second intermediate molecular structure of the complex, characterised in that the molecular dynamics simulation comprises exerting a supplemental force on one or more atoms or one or more groups of atoms of at least one of the constituent molecule(s) comprising backbone and side-chains such as to modify one or more side-chain dihedral angles of said molecule(s) to at least partly converge towards the corresponding side-chain dihedral angles of the target conformation of said molecule(s);
(ee) relaxing the second intermediate molecular structure of the complex by performing a molecular dynamics simulation thereon without exerting said supplemental forces, thereby determining a third intermediate molecular structure of the complex;
(ff) reiterating steps (cc) to (ee), wherein at each reiteration the third intermediate molecular structure of the complex determined in step (ee) is received in step (cc) instead of the starting molecular structure of the complex;
(gg) following the last repetition of step (ff), supplying the third intermediate molecular structure to a docking and side-chain packing simulation, thereby determining a fourth intermediate molecular structure of the complex;
(hh) reiterating steps (aa) to (gg), wherein at each reiteration the third intermediate molecular structure of the complex, as determined following the last repetition of step (ff), is received in step (aa) as the starting molecular structure of the complex, and the fourth intermediate molecular structure of the complex determined in step (gg) is received in step (bb) as the target molecular structure of the complex; and
(ii) optionally and preferably, outputting data comprising information on a molecular structure of the complex as determined in any of the preceding steps, to a data storage medium or to a consecutive method.

5. The method according to claim 4, wherein the target pose of at least one constituent of the complex as received in step (bb1) differs from the starting pose of said at least one constituent as received in step (aa2), and wherein the step (dd) further comprises exerting a supplemental force on one or more atoms or one or more groups of atoms of said at least one constituent of the complex such as to modify the pose of said constituent(s) to at least partly converge towards the target pose of said constituent(s).

6. The method according to claim 4, wherein backbone conformation of constituent molecule(s) comprising backbone and side-chains is identical or substantially identical between the starting and target molecular structures.

7. A method for determining a molecular structure of a complex comprising two or more constituents, wherein one or more of said constituents is a molecule comprising backbone and side-chains, the method comprising the steps:
(a), (b), (c), (d), (e), (f) and (g) and optionally (b*), as defined in claim 1; or
(a), (b), (c), (d), (e) and (g), and optionally (b*) as defined in claim 1; or
(a), (b), (c), (d) and (g), and optionally (b*), as defined in claim 1; or
(aa), (bb), (cc), (dd), (ee), (ff), (gg), (hh) and (ii), as defined claim 4; or
(aa), (bb), (cc), (dd), (ee), (ff), (gg) and (ii), as defined in claim 4;
(aa), (bb), (cc), (dd), (ee), (ff) and (ii), as defined in claim 4.

8. A method for determining a conformation of a molecule comprising a backbone and side-chains, said method comprising:
(aaa) receiving a starting conformation of said molecule, and optionally receiving a starting pose of said molecule;
(bbb) receiving a target conformation of said molecule, wherein one or more side-chain dihedral angles differ between said starting and target conformations, and optionally receiving a target pose of said molecule;
(ccc) perturbing the starting conformation by performing a molecular dynamics simulation thereon, thereby determining a first intermediate conformation of said molecule, characterised in that the molecular dynamics simulation comprises exerting a supplemental force on one or more atoms or one or more groups of atoms of said molecule such as to modify one or more side-chain dihedral angles of said molecule to at least partly converge towards the corresponding side-chain dihedral angles of said target conformation of the molecule;
(ddd) relaxing said first intermediate conformation by performing a molecular dynamics simulation thereon without exerting said supplemental forces, thereby determining a second intermediate conformation of said molecule; and
(eee) optionally and preferably, outputting data comprising information on a conformation of said molecule as determined in any of the preceding steps, to a data storage medium or to a consecutive method.

9. The method according to claim 8, wherein the target pose of the molecule as received in step (bbb) differs from the starting pose of said molecule received in step (aaa), and wherein the step (ccc) further comprises exerting a supplemental force on one or more atoms or one or more groups of atoms of said molecule such as to modify the pose of said molecule to at least partly converge towards the target pose of said molecule.

10. The method according to claim 8, wherein backbone conformation of the molecule comprising backbone and side-chains is identical or substantially identical between the starting and target molecular conformations.

11. The method according to claim 8, further comprising step (ddd*) and optionally step (ddd**) between the steps (ddd) and (eee):
(ddd*) supplying the second intermediate conformation of the molecule to a side-chain packing simulation, thereby determining a third intermediate conformation of the molecule;
(ddd**) reiterating steps (aaa) to (ddd*), wherein at each reiteration the second intermediate conformation of the molecule determined in step (ddd) is received in step (aaa) as the starting conformation of the molecule, and the third intermediate conformation of the molecule determined in step (ddd*) is received in step (bbb) as the target conformation of the molecule.

12. The method according to claims 1, 4 or 8, wherein one or more said constituent(s) or molecule(s), preferably wherein one or more said molecule(s) comprising backbone and side-chains, is a biomolecule, more preferably a peptide, polypeptide or protein.

13. The method according to any one of claims 1, 4 or 8, wherein molecular dynamics simulations are performed using GROMACS and/or docking and side-chain packing simulations are performed using Rosetta preferably RosettaDock.

14. The method according to any one of claims 1, 4 or 8, wherein molecular dynamics simulations are performed in vacuum, or in the presence of an implicit solvent, or in the presence of an explicit solvent.

15. The method according to any one of claims 1, 4 or 8, wherein supplemental forces in molecular dynamics simulations are imposed through restraints chosen from dihedral angle restraints, position restraints including linear position restraints and/or harmonic position restraints, and conformational restraints.

16. The method according to claims 1, 4 or 8, wherein side-chain dihedrals are computed for and compared between the starting and target molecular structures of a molecule or complex, yielding for each side-chain dihedral a difference (Δ_{DIH}) between its value in the starting structure (starting value) and its value in the target structure (target value), and further wherein a supplemental force is exerted to modify a dihedral angle if Δ_{DIH} for said dihedral angle exceeds a set value and said supplemental force is lowered towards zero when Δ_{DIH} is 0, and:
optionally wherein the supplemental force exerted to modify a dihedral angle whose Δ_{DIH} is greater than the set value is increased in function of the magnitude of said Δ_{DIH} and/or in function of duration of the simulation, or
optionally wherein the supplemental force exerted to modify a dihedral angle whose Δ_{DIH} is greater than the set value does not increase in function of duration of the simulation, an preferably wherein the simulation time is variable.

17. The method according to claims 1, 4 or 8, wherein the force constant and/or increment of the supplemental force exerted to modify dihedral angles is equal for all dihedral angles of a given side chain; or wherein the force constant and/or increment of said supplemental force is greater for side-chain dihedral angles farther away from the backbone; or wherein the force constant and/or increment of said supplemental is greater for side-chain dihedral angles closer to the backbone.

18. A computing device such as a computer configured to perform the method of any one of claims 1, 4 or 8.

19. A program such as a software product, configured to execute the method of any one of claims 1, 4 or 8 on a computing device such as a computer.

20. A computer-readable storage medium storing the program of claim 19.
